(19) United States
(12) Patent Application Publication
(10) Pub. No.: US 2024/0318912 A1
(43) Pub. Date: Sep. 26, 2024

(54) DRYING DEVICE AND METHOD FOR DRYING CONTAINER UNITS EXHIBITING SOLVENT

(71) Applicant: BELVAC PRODUCTION MACHINERY, INC., Lynchburg, VA (US)

(72) Inventors: Wilko HARMS, Wittmund (DE); Ulf REINHARDT, Teutschenthal (DE)

(21) Appl. No.: 18/580,589

(22) PCT Filed: Jul. 11, 2022
(86) PCT No.: PCT/DE2022/100497

§ 371 Date: Jan. 18, 2024

(30) Foreign Application Priority Data
Jul. 19, 2021 (DE) 10 2021 118 534.3

(51) Int. Cl. F26B 21/12; F26B 3/04; F26B 15/18; F26B 21/04; F26B 25/00

(52) U.S. Cl. CPC F26B 21/12; F26B 3/04; F26B 15/18; F26B 21/04; F26B 25/009

(57) ABSTRACT

The invention relates to a drying device for drying container units, in particular cans, exhibiting solvent, comprising a drying chamber with an inlet side and an outlet side, in which a process fluid is able to be applied to the container units, a conveying unit which is arranged and configured to move the container units through the drying chamber from the inlet side to the outlet side, a fluid-flow device which is arranged and configured to provide the process fluid and to apply a fluid flow of the process fluid to the container units within the drying chamber, and a control device which is designed to control the fluid-flow device on the basis of a determined solvent input.

### CROSS-REFERENCE TO RELATED APPLICATIONS

This application is a U.S. national stage of International Application No. PCT/DE2022/100497, filed Jul. 11, 2022, which claims the benefit of and priority to German Patent Application No. 10 2021 118 534.3, filed Jul. 19, 2021, each of which are hereby incorporated by reference herein in its entirety.

### FIELD

The invention relates to a drying device and a method for drying container units exhibiting solvents, in particular cans, for example cans made of aluminum or steel, which are intended in particular for storing food and beverages.

### BACKGROUND

Drying devices for drying container units exhibiting solvents are generally known. Such drying devices are provided, for example, as a continuous oven with a conveyor belt, wherein the cans are moved through the oven by means of the conveyor belt and are exposed to hot air during this process. Furthermore, such drying devices can exhibit chains with pins for conveying the cans. Typically, such an oven exhibits several drying chambers arranged in series, in which water evaporates, the cans are heated to a target temperature, and remain at the target temperature for a predefined period of time in order to remove water from the cans and/or to ensure polymerization of a coating.

Such an oven is also referred to as a paint drying oven, which is configured in particular to dry and/or polymerize an interior coating and/or an exterior coating of a can.

The operation of such ovens is energy-intensive. The operation of exhaust air fans, which remove the air from the drying chambers, is particularly energy-intensive. Since such an oven can dry and polymerize up to 6,000 cans per minute, the amount of exhaust air required is high. A high exhaust air volume also means that more fresh air has to be fed into the drying chambers. This fresh air is usually heated to a predefined temperature by means of a gas burner in order to be mixed with recirculated air and fed into the drying chamber.

Furthermore, such ovens are usually controlled on the basis of a minimum exhaust air volume, which must not be undercut during operation. The minimum exhaust air volume is determined specifically for each stove. In particular, the minimum exhaust air volume is determined on the basis of a maximum number of cans per minute and on the basis of a maximum can size.

WO 2016/124 673 A1 describes an adjustment of an exhaust air volume during a cold start or when the can supply is interrupted to a first value and a second value, wherein the first value is suitable for the drying process and wherein the second value enables a rinsing adjustment with a rinsing time of 5-10 minutes. Adjustment of a first value and a second value for the exhaust air volume does not allow efficient control of the exhaust air volume, as the actual exhaust air volume cannot be precisely adjusted to an optimum exhaust air volume.

WO 2014/166 831 A1 discloses a method and a device for minimizing the exhaust air from a drying room, wherein an adjusting element for switching between a supply air and a recirculated air is provided for this purpose. The actuator is controlled on the basis of the humidity of the air in the drying chamber. It is not possible to adjust an exhaust air flow that minimizes consumption because only the supply air and recirculated air states can be set.

It is an industry requirement that such ovens exhibit the lowest possible energy consumption. In particular, the increasing requirements with regard to ecological boundary conditions make it a goal to design such ovens to be more energy-efficient. This also improves the ecological footprint of each can, so that considering an annual can volume of several hundred billion, which is produced on more than 600 lines worldwide with a capacity of more than one billion cans per year, a major impact on the ecological footprint is possible.

It is therefore a task of the invention to provide a drying device and a method for drying container units exhibiting solvents, in particular cans, which reduce or eliminate one or more of the disadvantages mentioned. In particular, it is a task of the invention to provide a solution that enables energy-efficient drying of container units exhibiting solvents.

This problem is solved with a drying device and a method according to the features of the independent patent claims. Further advantageous embodiments of these aspects are disclosed in the respective dependent claims. The features listed individually in the patent claims and the description can be combined with one another in any technologically meaningful way, wherein further embodiments of the invention are shown.

### SUMMARY

According to one embodiment, a drying device for drying container units exhibiting solvent—is disclosed. The drying device includes a drying chamber with an inlet side and an outlet side, in which a process fluid is applied to the container units. The drying device further includes a conveying unit arranged and configured to move the container units from the input side to the output side through the drying chamber. The drying device further includes a fluid flow device arranged and configured to provide the process fluid and to apply a fluid flow of the process fluid to the container units within the drying chamber. The drying device further includes a control device which is set up to control the fluid flow device based on a determined solvent input.

According to another embodiment, a method for drying container units exhibiting solvent is disclosed. The method includes moving the container units through a drying chamber. The method further includes determining a solvent input into the drying chamber caused by the container units. The method further includes applying a fluid flow of a processing fluid to the container units. The method further includes adjusting a fluid flow flowing out of the drying chamber based on the determined solvent input.

### BRIEF DESCRIPTION OF THE DRAWINGS

FIG. 1: a schematic two-dimensional view of an exemplary embodiment of a drying device;

FIG. 2: a schematic, two-dimensional top view of the drying device shown in FIG. 1;

FIG. 3: a schematic, two-dimensional detailed view of the drying device shown in FIG. 1 with a container unit inlet; and

FIG. 4: a schematic view of an exemplary embodiment of a method.

In the figures, identical or essentially functionally identical or similar elements are designated with the same reference symbols.

### DETAILED DESCRIPTION

According to a first aspect, the task mentioned at the beginning is solved by a drying device for drying container units exhibiting solvent, in particular cans, comprising a drying chamber with an inlet side and an outlet side, wherein a process fluid can be applied to the container units, a conveying unit which is arranged and configured to move the container units from the input side to the output side through the drying chamber, a fluid flow device which is arranged and configured to provide the process fluid and to apply a fluid flow of the process fluid to the container units within the drying chamber, and a control device which is set up to control the fluid flow device based on a determined solvent input.

The invention is based, among other things, on the realization that a significant influencing factor for controlling the fluid flow device is a solvent input into the drying chamber. The inventors have discovered that it is advantageous for efficient control of the fluid flow device if a determined solvent input is used as a basis rather than a predetermined solvent input value. The approach known from the European standard EN1539 of directly measuring the solvent content in the drying chamber ensures the safety of the oven, but cannot guarantee energy-efficient operation. Determining the solvent input ensures safety in accordance with the standard regardless of the degree of drying and thus also solves the problem that the solvent content depends on the temperature in the drying chamber.

Such a drying device can be controlled with a precisely adjusted fluid flow, wherein in particular a fluid flow of the process fluid flowing out of the drying chamber can be adjusted as required. As a result, the energy consumption of the drying device for drying the container units is reduced. This reduces the amount of energy required to produce a single can and improves its environmental footprint.

The invention is also based on the realization that the minimum exhaust air volume is often oversized with a lower number of cans per minute and/or with a smaller can size.

The inventors have therefore discovered that the minimum exhaust air volume can be determined dynamically.

Drying devices of the type mentioned above can also be configured as internal baking ovens. The drying device is preferably configured as a continuous oven or a continuous dryer. Furthermore, the drying device can preferably be configured as a paint drying oven. It may also be preferable for the drying device to be configured as a pin oven.

The container units are, for example, cans, in particular for storing food and/or drinks. Such container units can be made of steel or aluminum, for example. Such container units also usually exhibit a coating. This lacquer is applied to the outer and/or inner surfaces of the container units in a previous process step, wherein this lacquer contains solvents. As a rule, a coating is dried on an outer surface in a so-called pin oven and a coating is dried on the inner surface in an Internal Baking Oven, also known as an IBO.

Inside the drying device, the paint is dried and polymerized so that the solvents are removed from the container units. When controlling the drying device, it must be ensured, among other things, that the solvent content within the drying chamber, for example the solvent dissolved in the air of the drying chamber, does not exceed a predefined value. Above a certain level of solvent, there is a risk of explosion which must be avoided.

The drying device comprises the drying chamber with an input side and an output side. The drying chamber preferably exhibits a chamber inlet on the inlet side for the container units to enter and a chamber outlet on the outlet side for the container units to exit.

In addition, the drying chamber preferably exhibits one, two or more fluid supply lines, which are fluidically coupled in particular with the fluid flow device. It is also preferable for the drying chamber to be essentially configured as fluid-tight, for example by means of a chamber wall. Furthermore, the drying chamber is configured in such a way that the container units can be moved from the input side to the output side by means of the conveying unit. It is particularly preferred that the conveying unit extends through the drying chamber.

The conveying unit can, for example, exhibit a conveyor belt on which the container units can be arranged. In particular, the conveying unit can be configured as a belt conveyor. It is also preferred that the conveying unit moves the container units in an essentially horizontal direction.

In addition, the conveying unit can be configured as a chain with transport pins that can be used to hold the container units. Such a conveying unit is provided in particular in a pin oven, in which the chain is usually guided in a meandering pattern.

The fluid flow device is arranged and configured to provide the process fluid, in particular air, for example by conveying the process fluid from the environment into the drying chamber.

Furthermore, the fluid flow device is arranged and configured to apply a fluid flow of the process fluid to the container units within the drying chamber. The fluid flow can be specified in cubic meters per hour, for example. The process fluid is particularly gaseous.

The fluid flow device preferably exhibits three functionalities, namely applying the process fluid to the container units, causing the process fluid to flow out of the drying chamber and causing the process fluid to flow into the drying chamber. Furthermore, the fluid flow device can be arranged and configured to effect air recirculation.

The fluid flow device preferably exhibits a first fluid flow unit, which is configured to convey the process fluid out of the drying chamber. The fluid flow device is preferably configured as an exhaust air unit, in particular as an exhaust air fan. The exhaust air fan is preferably configured to convey the process fluid out of the drying chamber. Furthermore, the fluid flow device preferably exhibits a second fluid flow unit for generating recirculated air of the process fluid within the drying chamber. In addition, it may be preferable for the fluid flow device to exhibit a third fluid flow unit that controls an inflow of the process fluid into the drying chamber. The third fluid flow unit can be configured as a flap or a fan, for example. The first and/or second fluid flow unit can also be configured as a fan.

The drying device can also exhibit two or more fluid flow devices. It is particularly preferred that the drying device exhibits two or more drying chambers. It is preferred that each of the two or more drying chambers exhibits an associated fluid flow device.

Alternatively, it may be provided that a fluid flow device effects the fluid flows of the two or more drying chambers.

The drying device further comprises the control device, which is set up to control the fluid flow device based on a determined solvent input. The solvent input is determined and not specified or provided, for example by an upstream production facility. As will be explained in more detail below, the drying device can exhibit measuring units for this purpose in order to record measured values on the basis of which the solvent input can be determined. In this context, it is also possible to indirectly determine the solvent input, for example via a container unit density, a speed of the conveying unit and/or via a size of the container units.

The control device is preferably coupled to the fluid flow device by means of signals. The control device is preferably set up to adjust the fluid flow device essentially steplessly depending on the determined solvent input in order to apply the fluid flow exhibiting a predefined fluid flow characteristic to the container units. The fluid flow property can be, for example, a fluid pressure, which can be specified in Pascal (Pa), and/or a fluid volume flow, which can be specified in cubic meters per hour, for example.

Essentially stepless means in particular essentially continuous. Essentially stepless can also mean that the fluid flow device is not adjusted discretely. Essentially stepless can also mean that an adjusted fluid flow, for example measured in volume per unit of time, deviates less than 10%, less than 5%, or less than 2.5% from a predefined fluid flow, for example specified in volume per unit of time. Furthermore, essentially stepless can mean that the fluid flow device is adjustable with more than 10 steps, more than 20 steps, or more than 100 steps. Furthermore, essentially stepless can mean that a step distance between two successive steps is less than 10% of an adjustment range of the fluid flow device, less than 5% of the adjustment range, or less than 2.5% of the adjustment range.

Alternatively or additionally, the control device can be set up to control the fluid flow device directly based on a container unit density.

A preferred embodiment of the drying device is characterized in that the control device is set up to determine a target fluid flow as a function of the solvent input and to control the fluid flow device in such a way that a fluid flow flowing out of the drying chamber corresponds at least to the target fluid flow.

The fact that a fluid flow flowing out of the drying chamber corresponds at least to the target fluid flow means in particular that a difference between the outflowing fluid flow and the target fluid flow is less than 30%, less than 20%, less than 10%, or less than 5%.

A control device set up in this way has the advantage that the outflowing fluid flow only assumes a value that is required taking into account the actual solvent input. This means that the energy consumption of the fluid flow device is not higher than required by the process.

In a further preferred embodiment of the drying device, it is provided that the target fluid flow is selected in such a way that a solvent content in the drying chamber does not exceed a predetermined value. The solvent is present in the drying chamber, particularly in gaseous form. In particular, the solvent can be dissolved in the fluid, especially air, in the drying chamber. The solvent content can be specified, for example, in grams of solvent per cubic meter of air. The solvent content can also be given as a percentage, for example. The target fluid flow can also be described as a minimum fluid flow.

It is preferred that the predetermined value represents an explosion limit. Above a certain solvent content in the drying chamber, there is a risk of explosion. As a rule, it is imperative to avoid the solvent content reaching this limit. This enables an energy-efficient drying device, while at the same time ensuring a high level of safety against explosions.

A further preferred design of the drying device is characterized by the fact that the control device exhibits a safety unit which is set up so that the fluid flow flowing out of the drying chamber cannot be adjusted by an operator during intended operation. The function of the safety unit is also referred to as locking. Not adjustable by an operator means in particular that the outflowing fluid flow cannot be adjusted by more than 10%, more than 5%, or more than 2.5%. Intended operation means in particular that an operator cannot change the outflowing fluid flow without special qualifications. Special qualifications can be, for example, knowledge of a password or possession of a key.

The advantage of such a safety unit is that the drying device can always be operated at an optimum energy level and no significant manual manipulation is possible during normal operation. Furthermore, the safety of the drying device can be improved, as an operator cannot adjust the fluid flow device in such a way that an explosive mixture is created in the drying chamber.

It is furthermore preferred that the control device is set up to control the fluid flow device in such a way that the fluid flow flowing out of the drying chamber essentially corresponds to a fluid flow flowing into the drying chamber. This can be achieved, for example, by controlling an exhaust air fan and/or a supply air flap or a supply air fan. That the inflowing fluid flow essentially corresponds to the outflowing fluid flow means in particular that the difference between the inflowing fluid flow and the outflowing fluid flow is less than 30%, less than 20%, less than 10%, or less than 5%. Such control essentially prevents the process fluid from flowing into or out of the drying chamber through the inlets or outlets of the container units.

A preferred embodiment of the drying device is further characterized in that the control device is set up to determine the solvent input based on a container unit density, describing a number of container units per time unit entering the drying chamber, and/or based on a solvent quantity per container unit.

The container unit density can, for example, be specified in containers per minute, e.g., 2500 cans per minute. The quantity of solvent per container unit depends on various parameters of the container units. For example, the amount of solvent can be determined by the size of the container unit, the type of lacquer in the container unit, and the thickness of the lacquer. The quantity of solvent per container unit can be specified in grams, for example.

A further preferred embodiment of the drying device is characterized by the fact that it comprises a density measuring unit which is set up to detect the container unit density. In particular, the density measuring unit is coupled to the control device by means of signals.

The density measuring unit can be a counting unit, for example. The density measuring unit preferably comprises one, two or more optical sensors, for example light barriers, inductance sensors, color sensors, and/or infrared sensors.

Furthermore, the density measuring unit can exhibit inductance sensors, capacitance sensors, magnetic sensors, and/or proximity sensors, for example ultrasonic sensors. Furthermore, the density measuring sensors can be configured as such. Alternatively or additionally, the density measuring unit can exhibit a camera or a line control.

It is particularly preferred that the density measuring unit exhibits two or more density measuring sensors for redundant detection of the container unit density. Two or more density measuring sensors enable reliable detection of the container unit density, so that the solvent input determined by means of the container unit density is determined with a high degree of certainty.

In a further preferred embodiment of the drying device, it is provided that it comprises a condition measuring unit which is arranged and configured to detect a container condition, and wherein the control device is set up to determine a solvent quantity per container unit based on the detected container condition. The condition measuring unit is coupled in particular with the control device in terms of signal technology.

The amount of solvent per container unit can be determined, for example, based on a size of the container units, in particular a surface area and/or a height, a type of paint, and/or a color of the container unit. The condition measuring unit can, for example, be a light barrier for determining the size of the container units.

In addition, the condition measuring unit can be a camera for recording the condition of the container. It is particularly preferred that the condition measurement unit exhibits two or more condition measurement sensors so that a high level of determination accuracy can be implemented by means of redundant measurement.

In a further preferred embodiment of the drying device, it is provided that the container condition is a surface area, a height, and/or a color of the container units. The surface area of a container unit relates in particular to a peripheral surface of the container unit. The height of a container unit describes in particular the length of the container unit starting from a base.

A further preferred embodiment of the drying device is characterized in that it comprises a fluid flow measuring unit for detecting the fluid flow flowing out of the drying chamber and/or a fluid flow flowing into the drying chamber.

The fluid flow measuring unit preferably exhibits two or more fluid flow measuring sensors for redundant detection of the fluid flow. The drying device can, for example, exhibit a fluid outlet which is arranged and configured in such a way that the fluid flow can flow out of the drying chamber through it. It is preferable that the fluid flow measuring unit, in particular the two or more fluid flow measuring sensors, act within the fluid outlet, so that a high determination accuracy can be implemented.

A further preferred embodiment of the drying device comprises a heating device for heating the process fluid flowing into the drying chamber, wherein preferably the heating device exhibits a combustion unit, in particular a gas burner, and a tubular element surrounding the combustion unit at least in sections, wherein the tubular element exhibits fluid guiding elements arranged on an inner peripheral side in such a way that the process fluid flowing into the tubular element exhibits a swirl within the tubular element.

Combustion can be optimized using a tubular element of this type. The flame manipulated by the tubular element exhibits a helical shape. The process fluid carried along by the flame impulse is also set in rotation, which enables greater stability of the energy transfer. As a result, the uniformity of heating in the drying chamber can be optimized.

In a further preferred embodiment of the drying device, it is provided that it comprises a guide device arranged adjacent to the input side for guiding the container units onto a side section of the conveying unit. For example, the conveying unit can exhibit a left-hand side section and a right-hand side section. The side section can take up any extension of the width of the conveying unit, for example 50% of the width. The guide device can, for example, be a beam arranged above the conveying unit, the clear height of which above the conveying unit is less than the height of the container units.

The control device is preferably set up to control the guide device as a function of the container unit density in such a way that the container units are moved through the drying chamber at a predetermined distance. By means of a control device set up in this way, the container units can be moved compactly through the drying chamber, in particular with little or no spacing.

It is also preferred that the fluid flow device is arranged and configured to direct the fluid flow to the side section. By guiding the container units compactly through the drying chamber and directing the fluid flow to the side section exhibiting the container units, the energy requirement of the drying device can be reduced.

In particular, the fluid flow is therefore essentially not applied to the section of the conveying unit in which no container units are moved. For this purpose, the fluid flow device can, for example, exhibit fluid flow nozzles that can be switched off and/or moved, in particular swiveled. In particular, the control device is set up to control the fluid flow device in such a way that the fluid flow is directed to the side section.

Furthermore, it is preferred that the two or more drying chambers are fluidically coupled to each other in such a way that a process fluid from one drying chamber is fed into a previous drying chamber.

In a further preferred embodiment of the drying device, it is provided that it comprises a fluid barrier device at a container unit inlet and/or at a container unit outlet, the fluid barrier device exhibiting a height-adjustable fluid outlet for adjusting a clearance height above the conveying unit, and preferably the control device being set up to set the clearance height as a function of the height of the container units. This means that a better drying effect can be achieved with a lower exhaust air requirement.

According to a further aspect, the task mentioned at the beginning is solved by a method for drying container units exhibiting solvents, in particular cans, comprising the steps of: moving the container units through a drying chamber, determining a solvent input into the drying chamber caused by the container units, applying a fluid flow of a process fluid to the container units, and adjusting a fluid flow flowing out of the drying chamber based on the determined solvent input.

The method and its possible embodiments exhibit features or method steps which make them particularly suitable for use in a drying device and its embodiments.

For further advantages, embodiment variants and embodiment details of the method and possible embodiments, reference is also made to the previous description of the corresponding features and embodiments of the drying device.

Preferred exemplary embodiments will now be described by reference to the accompanying figures by way of examples.

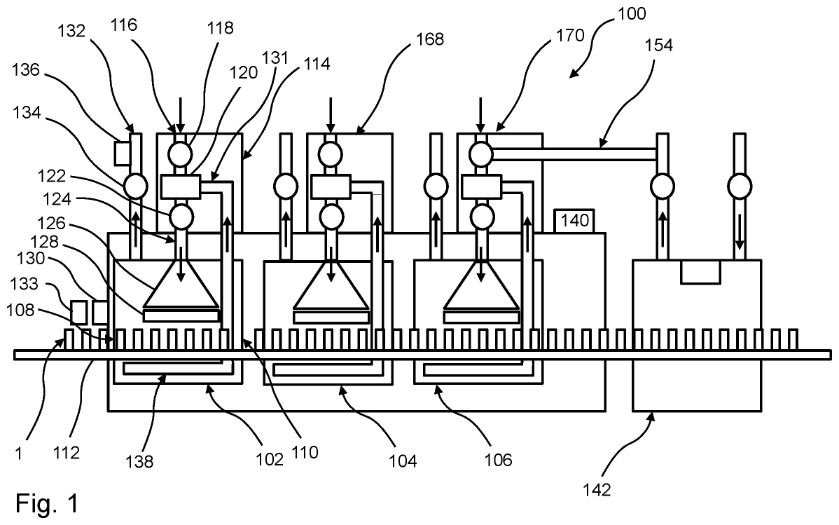

FIG. 1 shows a drying device 100 with a first drying chamber 102, a second drying chamber 104, and a third drying chamber 106. Furthermore, the drying device 100 comprises a cooling section 142. A conveying unit 112 extends through the drying chambers 102, 104, 106, and the cooling section 142. Container units 1 are moved through the drying device 100 by means of the conveying unit 112.

The drying chambers 102, 104, 106 exhibit a similar structure, so that only the drying chamber 102 is described in detail below, wherein these explanations also apply to the drying chamber 104 and the drying chamber 106 with the necessary modifications. The drying chamber 102 extends in a horizontal direction from an entry side 108, at which the container units enter the drying chamber 102, to an exit side 110, at which the container units 1 leave the drying chamber 102 again.

Furthermore, the drying device 100 exhibits a fluid flow device 114 that is fluidically coupled to the drying chamber 102. Further, the drying device 100 exhibits a second fluid flow device 168 fluidly coupled to the drying chamber 104 and a third fluid flow device 170 fluidly coupled to the drying chamber 106.

The fluid flow device 114 exhibits a fluid inlet 116 through which a process fluid, in this case air, can enter the fluid flow device 114. A supply air fan 118 is arranged in a fluid flow direction downstream of the fluid inlet 116, which guides the air flowing into the fluid flow device 114 to a heating device 120. Alternatively, the supply air fan 118 can also be configured as a flap. The heating device 120 can be a gas burner, for example.

Downstream of the heating device 120, a recirculated air fan 122 is arranged, which causes a fluid flow into the drying chamber 102. For this purpose, the recirculated air fan 122 is fluidically coupled to the drying chamber 102 by means of a fluid guide 124.

Within drying devices, uniformity problems often occur with the air flow, wherein the aim is to direct the air as evenly as possible onto the container units 1. For this purpose, the fluid flow device 114 exhibits a first fluid distribution unit 126, which in the present case is configured as a V-orifice. A second fluid distribution unit 128 is provided downstream, which ensures further optimized distribution of the process fluid.

The second fluid distribution unit 128 is configured as a perforated plate. From there, the air reaches the container units 1, which are moved under the fluid flow unit 114 by means of the conveying unit 112.

The conveying unit 112 is preferably configured to be permeable to air. As a result, after the air has passed through the container units 1, it passes under the conveying unit 112, where it meets a fluid collection channel 138. The fluid collection duct 138 returns the process fluid to the heating device 120 by means of a recirculated air duct 131. The use of such recirculated air reduces the energy requirement of the fluid flow device 114.

In order not to exceed a maximum value of a solvent content in the drying chamber 102, part of the process fluid should flow out of the drying chamber 102. For this purpose, the fluid flow device 114 exhibits a fluid outlet 132 which is fluidically coupled to an exhaust air fan 134. Furthermore, a fluid flow measuring unit 136 is arranged at the fluid outlet 132, which is arranged and configured to measure a fluid flow flowing out of the drying chamber 102, for example in cubic meters per hour.

In addition, the drying device 100 exhibits a density measuring unit 130 for determining the containers entering the drying chamber 102 per unit of time. Furthermore, a condition measuring unit 133 is provided, by means of which at least one container unit condition can be determined.

A control device 140 is arranged to control the fluid flow device 114 based on a determined solvent input. In particular, the control device 140 is arranged to determine a target fluid flow to be discharged from the drying chamber 102 as a function of the solvent input and to control the fluid flow device 114 in such a way that a fluid flow discharging from the drying chamber 102 at least corresponds to the target fluid flow. For example, the target fluid flow may be a minimum fluid flow selected such that a solvent content in the drying chamber 102 does not exceed a predetermined value, preferably the predetermined value representing an explosion limit.

In particular, the control device 140 is set up to determine the solvent input based on a container unit density, describing the container units 1 entering the drying chamber 102 per time unit and/or based on a solvent quantity per container unit 1. The container unit density can also be provided as a value of the control device 140, in particular by a device arranged upstream of the drying device 100, for example a painting system. The control device 140 is coupled in particular with the density measuring unit 130 and the condition measuring unit 133 by means of signals, so that the control device 140 can determine the solvent input on the basis of measured values from the density measuring unit 130 and the condition measuring unit 133. In addition, the measured value of the density measuring unit 130 and the provided value of the container unit density described above can also be taken into account in order to ensure a high level of safety by means of redundancy.

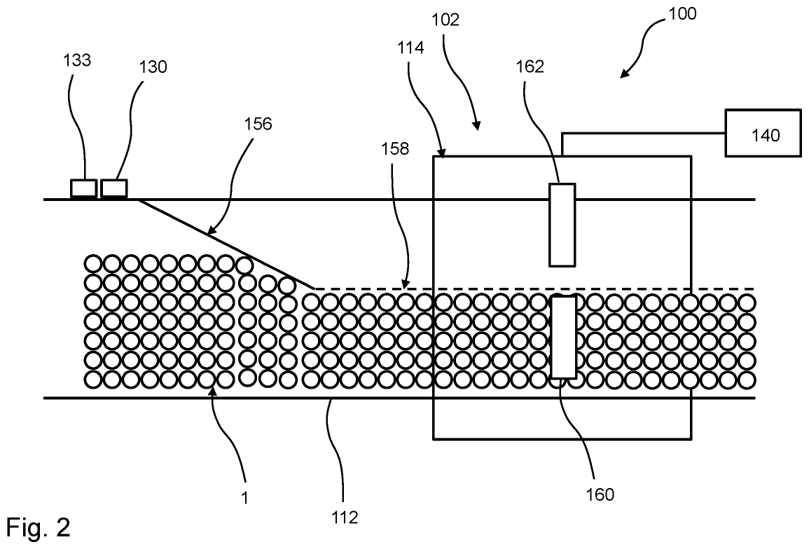

FIG. 2 shows a top view of the drying device 100 described above. In particular, it can be seen here that the drying device 100 exhibits a guide device 156 for guiding the container units 1 onto a side section 158 of the conveying unit 112. The dashed line represents the boundary of side section 158. It can be seen that the section of the conveying unit 112 next to the side section 158 does not exhibit any container units 1.

As a result, the fluid flow device 114 can be controlled by the control device 140 in such a way that the process fluid is only applied to the side section 158 and not or less than the area in which there are no container units 1. In the present case, only the first fluid outlet 160 is active, so that the process fluid is only applied to the container units 1 located below the first fluid outlet 160. The second fluid outlet 162 is deactivated so that process fluid does not escape here unnecessarily.

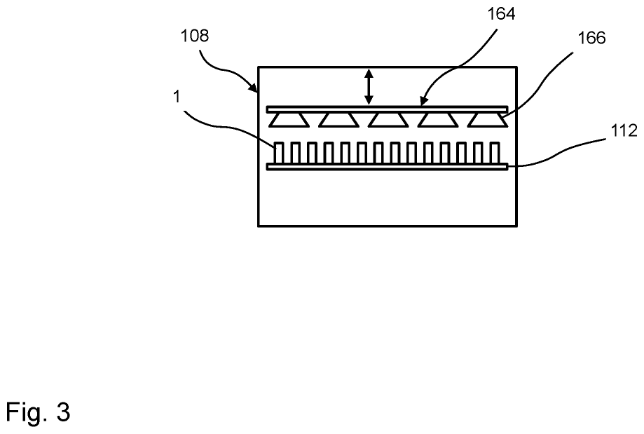

FIG. 3 shows a detailed view of the entrance side 108 of the drying chamber 102. The drying device 100 comprises a fluid barrier device 164 at the container unit inlet, the fluid barrier device 164 exhibiting a height-adjustable fluid outlet 166 for adjusting a clearance height above the conveying unit 112. In particular, the control device 140 is set up to adjust the clear height depending on the height of the container units 1. The clear height is preferably adjusted so that it is slightly greater than the height of the container units 1, so that as little process fluid as possible can flow from the inside of the drying chamber to the outside or, in the event of negative pressure, can enter the drying chamber 102 from the outside.

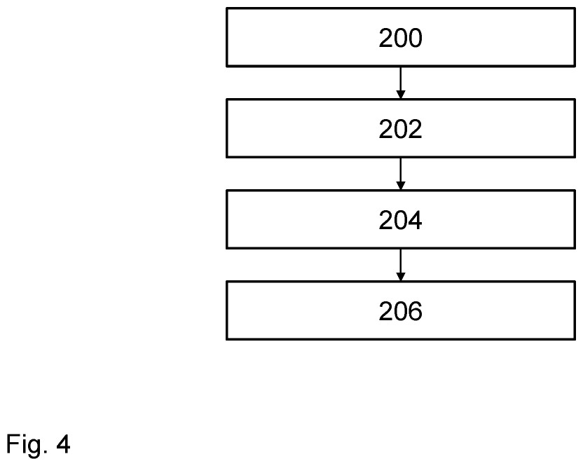

FIG. 4 shows a method for drying container units 1 exhibiting solvents, in particular cans. In step 200, container units 1 are moved through a drying chamber 102, 104, 106. In step 202, a solvent input into the drying chamber 102, 104, 106 effected by the container units 1 is determined. In step 204, a fluid flow of a process fluid is applied to the container units 1. Further, in step 206, a fluid flow exiting the drying chamber 102, 104, 106 is adjusted based on the determined solvent input.

With a drying device 100 described above, more efficient operation is possible. In particular, by optimizing the fluid flow device 114, 168, 170 of the drying device 100, significant energy can be saved, since the fluid flow device 114, 168, 170, in particular the individual fans, exhibit a high energy consumption. In addition, the fluid flow device 114 can be controlled in a targeted manner on the basis of the solvent input so that, on the one hand, operation is optimized in terms of energy and, on the other hand, sufficient air exchange is generated so that the solvent content does not exceed a preferably predefined maximum value.

### REFERENCE NUMERALS

1 container units
100 drying device
102 first drying chamber
104 second drying chamber
106 third drying chamber
108 input side
110 output side
112 conveying unit
114 fluid flow device
116 fluid inlet
118 supply air fan
120 heating device
122 recirculated air fan
124 fluid guide
126 first fluid distribution unit
128 second fluid distribution unit
130 density measuring unit
131 recirculated air duct
132 fluid outlet
133 condition measuring unit
134 exhaust air ventilator
136 fluid flow measuring unit
138 fluid collection channel
140 control device
142 cooling section
154 fluid return unit
156 guide device
158 side section
160 first fluid outlet
162 second fluid outlet
164 fluid barrier device
166 fluid outlet
168 second fluid flow device
170 third fluid flow device

1. A drying device for drying container units exhibiting solvent comprising:
a drying chamber with an inlet side and an outlet side, in which a process fluid is applied to the container units;
a conveying unit arranged and configured to move the container units from the input side to the output side through the drying chamber;
a fluid flow device arranged and configured to provide the process fluid and to apply a fluid flow of the process fluid to the container units within the drying chamber; and
a control device which is set up to control the fluid flow device based on a determined solvent input.

2. A drying device according to claim 1, wherein the control device is set up to determine a desired fluid flow as a function of the solvent input and to control the fluid flow device in such a way that a fluid flow flowing out of the drying chamber corresponds at least to the desired fluid flow.

3. A drying device according to any claim 1, wherein the target fluid flow is selected such that a solvent content in the drying chamber does not exceed a predetermined value.

4. A drying device according to claim 1, wherein the control device exhibits a safety unit which is set up so that the fluid flow flowing out of the drying chamber cannot be adjusted by an operator during intended operation.

5. A drying device according to claim 1, wherein the control device is arranged to control the fluid flow device such that the fluid flow flowing out of the drying chamber substantially corresponds to a fluid flow flowing into the drying chamber.

6. A drying device according to claim 1, wherein the control device is set up to determine the solvent input based on a container unit density, describing a container unit number entering the drying chamber per time unit and/or based on a solvent quantity per container unit.

7. A drying device according to claim 1, comprising a density measuring unit, arranged for detecting the container unit density, wherein preferably the density measuring unit exhibits two or more density measuring sensors for redundantly detecting the container unit density.

8. A drying device according to claim 1, comprising a condition measuring unit which is arranged and configured to detect a container condition, and wherein the control device is set up to determine a solvent quantity per container unit based on the detected container condition.

9. A drying device according to claim 1, wherein the container condition is a surface area, a height and/or a color of the container units.

10. A drying device according to claim 1, comprising a fluid flow measuring unit for detecting the fluid flow flowing out of the drying chamber and/or a fluid flow flowing into the drying chamber, wherein preferably the fluid flow measuring unit exhibits two or more fluid flow measuring sensors for redundantly detecting the fluid flow.

11. A drying device according to claim 1, comprising a heating device for heating the process fluid flowing into the drying chamber, wherein preferably the heating device exhibits a combustion unit and a tubular element surrounding the combustion unit at least in sections, wherein the tubular element exhibits fluid guiding elements arranged on an inner peripheral side in such a way that the process fluid flowing into the tubular element exhibits a swirl within the tubular element.

12. A drying device according to claim 1, comprising a guide device arranged adjacent to the input side for guiding the container units onto a side section of the conveying unit, wherein preferably the control device is arranged to control the guide device as a function of the container unit density in such a way that the container units are moved through the drying chamber at a predetermined distance.

13. A drying device according to claim 1, wherein the fluid flow device is arranged and configured to direct the fluid flow towards the side section.

14. A drying device according to claim 1, comprising a fluid barrier device at a container unit inlet and/or at a container unit outlet, wherein the fluid barrier device exhibits a height-adjustable fluid outlet for adjusting a clearance height above the conveying unit, and preferably the control device is set up to set the clear height as a function of the height of the container units.

15. A method for drying container units exhibiting solvent comprising the steps:
moving the container units through a drying chamber;
determining a solvent input into the drying chamber caused by the container units;
applying a fluid flow of a processing fluid to the container units; and
adjusting a fluid flow flowing out of the drying chamber based on the determined solvent input.
